(19) United States
(12) Patent Application Publication
(10) Pub. No.: US 2009/0086729 A1
(43) Pub. Date: Apr. 2, 2009

(54) User datagram protocol (UDP) transmit acceleration and pacing

(76) Inventors: Parthasarathy Sarangam, Portland, OR (US); Sujoy Sen, Portland, OR (US)

Correspondence Address: Caven & Aghevli LLC;c/o CPA Global, P.O. BOX 52050, MINNEAPOLIS, MN, 55402, US

(21) Appl. No.: 11/904,919

(22) Filed: Sep. 28, 2007

(51) Int. Cl. H04L 12/56

(52) U.S. Cl. 370/389

(57) ABSTRACT

Methods and apparatus relating to User Datagram Protocol (UDP) transmit acceleration and/or pacing are described. In one embodiment, a data movement module (DMM) may segment a UDP packet payload into a plurality of segments. The size of each of the plurality of segments may be less than or equal to a maximum transmission unit (MTU) size in accordance with a user datagram protocol (UDP). Other embodiments are also disclosed.

### BACKGROUND

The present disclosure generally relates to the field of electronics. More particularly, some of the embodiments generally relate to User Datagram Protocol (UDP) transmit acceleration and/or pacing.

In some current networking implementations, TCP (Transmission Control Protocol) may be applied more frequently than UDP, primarily due to lack of reliability over UDP. UDP may however be facing a resurgence in light of grid and cluster computing as well as Internet Protocol (IP) based video streaming to end users (e.g., in homes). For example, UDP may be used in such applications due to its relatively better small packet performance and more favorable latency characteristics, as well as its ability to perform IP multicasting. Improved UDP implementations may further increase its usage.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures may indicate a similar item.

FIG. 1 illustrates various components of an embodiment of a networking environment, which may be utilized to implement various embodiments discussed herein.

FIG. 2 illustrates a block diagram of an embodiment of a computing system, which may be utilized to implement some embodiments discussed herein.

FIGS. 3-4 illustrate flow diagrams of methods according to some embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Some of the embodiments discussed herein may improve the performance of UDP in networking environments (e.g., over the Internet or an intranet). In some embodiments, UDP performance may be improved through hardware-based acceleration techniques discussed herein. For example, UDP acceleration and/or pacing may be provided through stateless hardware assist(s) for UDP specific transmission requests in some embodiments. In an embodiment, processor cycles to process UDP transmit requests may be reduced by offloading some of the tasks to other logic (such as a data movement module or network controller, including a network interface card (NIC) for example). In an embodiment, multicast processing may also be offloaded from a processor (to a NIC for example) to lower memory bandwidth utilization.

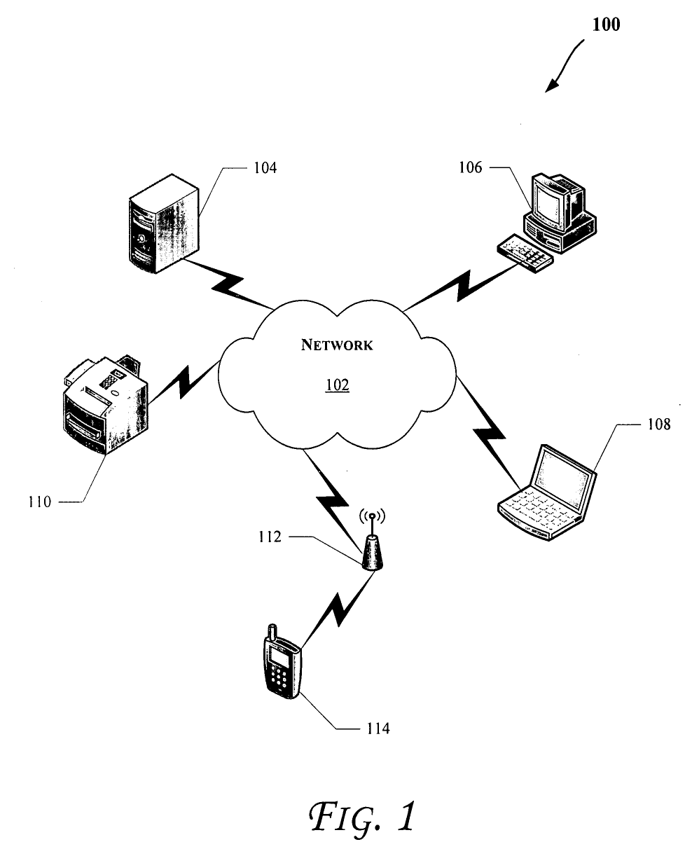

While in some embodiments UDP may be utilized over Ethernet, it does not necessarily have to be and may be used over other types of networks such as those discussed herein with reference to FIG. 1, for example. Further, a UDP header may consist of four fields, including a source port field, destination port field, length field, and checksum field. The use of source port and checksum fields is optional. The source port field identifies the sending port when meaningful and should be assumed to be the port to reply to if needed. If not used, then it should be zero. The destination port field identifies the destination port and is required. The length field is a 16-bit field that specifies the length in bytes of the entire datagram: header and data. The minimum length is 8 bytes since that's the length of the header. The field size sets a theoretical limit of 65,527 bytes for the data carried by a single UDP datagram. The practical limit for the data length which is imposed by the underlying IPv4 protocol is 65,507 bytes. The checksum field is a 16-bit checksum field which is used for error-checking of the header and data.

FIG. 1 illustrates various components of an embodiment of a networking environment 100, which may be utilized to implement various embodiments discussed herein. The environment 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, etc.), a wireless access point 112, a personal digital assistant or smart phone 114, a rack-mounted computing system (not shown), etc. The network 102 may be any type of a computer network including an intranet, the Internet, and/or combinations thereof.

The devices 104-114 may be coupled to the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In one embodiment, the wireless access point 112 may include traffic management capabilities. Also, data communicated between the devices 104-114 may be encrypted (or cryptographically secured), e.g. to limit unauthorized access.

The network 102 may utilize any type of communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) or external network interface devices (e.g., having a separate physical enclosure and/or power supply than the computing system to which it is coupled) such as a network interface card (NIC).

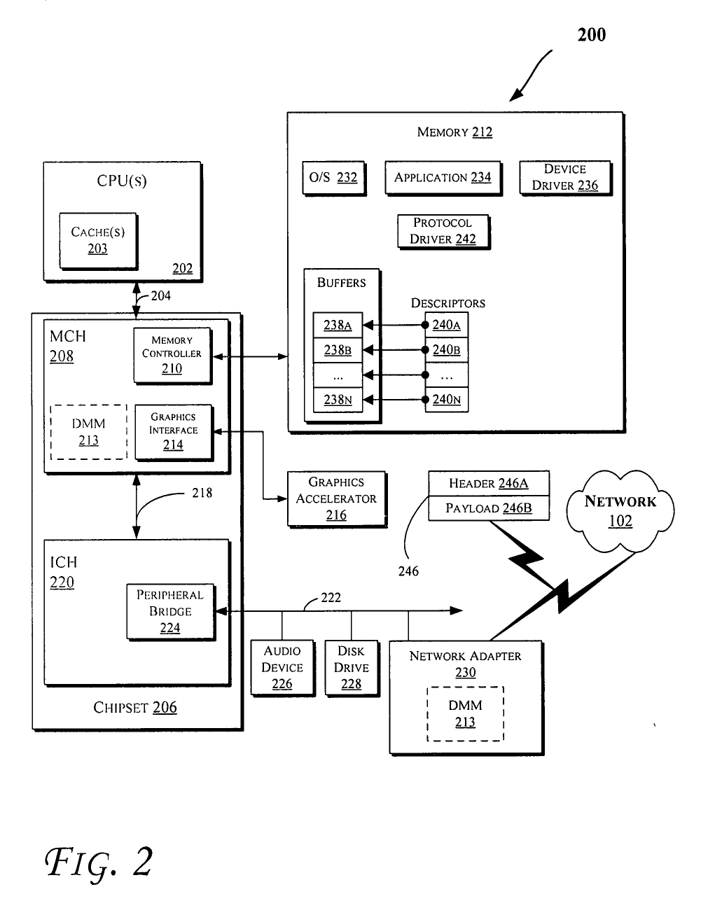

FIG. 2 illustrates a block diagram of an embodiment of a computing system 200. One or more of the devices 104-114 discussed with reference to FIG. 1 may comprise one or more of the components of the computing system 200. The computing system 200 may include one or more central processing unit(s) (CPUs) 202 or processors coupled to an interconnection network (or bus) 204. The processors 202 may be any type of a processor such as a general purpose processor, a network processor (e.g., a processor that processes data communicated over a network such as the network 102 of FIG. 1), etc. (including a reduced instruction set computer (RISC) processor or a complex instruction set computer (CISC)). Moreover, the processors 202 may have a single or multiple core design. The processors 202 with a multiple core design may integrate different types of processor cores on the same integrated circuit (IC) die. Also, the processors 202 with a multiple core design may be implemented as symmetrical or asymmetrical multiprocessors.

The processor 202 may include one or more caches 203 which may be shared (e.g., amongst cores of the processor 202) in one embodiment of the invention. Generally, a cache stores data corresponding to original data stored elsewhere or computed earlier. To reduce memory access latency, once data is stored in a cache, future use may be made by accessing a cached copy rather than refetching or re-computing the original data. The cache 203 may be any type of cache, such a level 1 (L1) cache, a level 2 (L2) cache, a level 3 (L-3), mid-level cache (MLC), last-level cache (LLC), etc. to store data (including instructions) that are utilized by one or more components coupled to the system 200.

A chipset 206 may additionally be coupled to the interconnection network 204. The chipset 206 may include a memory control hub (MCH) 208. The MCH 208 may include a memory controller 210 that is coupled to a memory 212. The memory 212 may store data and sequences of instructions that are executed by the processor 202, or any other device included in the computing system 200. In one embodiment of the invention, the memory 212 may include one or more volatile storage (or memory) devices such as random access memory (RAM), dynamic RAM (DRAM), synchronous DRAM (SDRAM), static RAM (SRAM), etc. Nonvolatile memory may also be utilized such as a hard disk. Additional devices may be coupled to the interconnection network 204, such as multiple processors and/or multiple system memories.

The MCH 208 may also include a graphics interface 214 coupled to a graphics accelerator 216. In one embodiment, the graphics interface 214 may be coupled to the graphics accelerator 216 via an accelerated graphics port (AGP). In an embodiment of the invention, a display (such as a flat panel display) may be coupled to the graphics interface 214 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

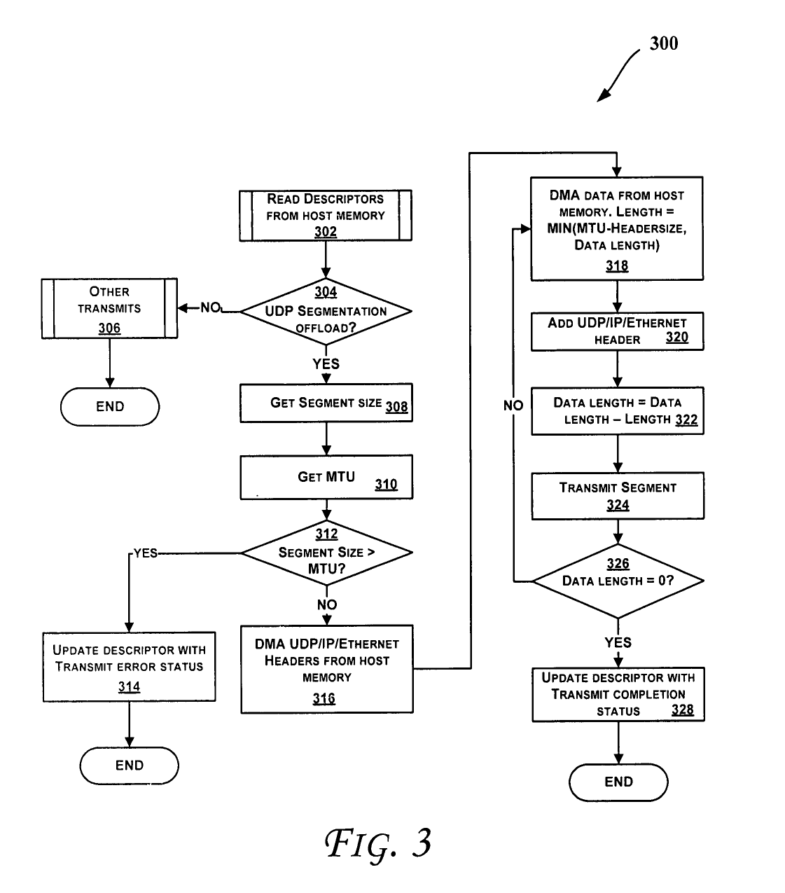

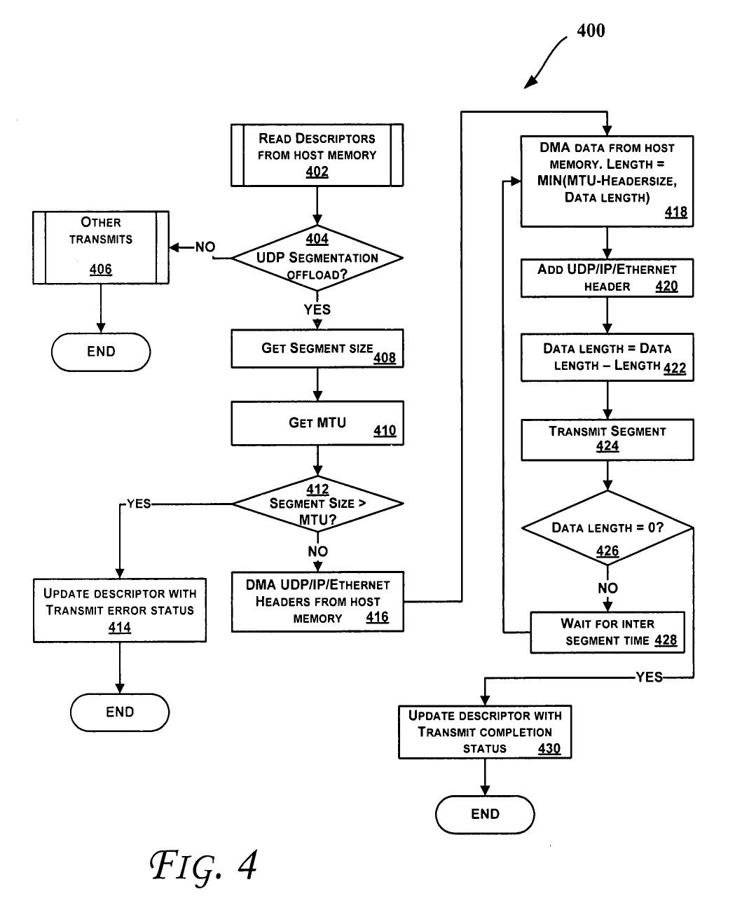

The MCH 208 may further include a data movement module (DMM) 213, such as a DMA (direct memory access) engine used to move data in accordance with UDP. As will be further discussed herein, e.g., with reference to FIGS. 3-4, the DMM 213 may provide data movement support to improve the performance of a computing system (200). For example, in some instances, the DMM 213 may perform one or more data copying tasks instead of involving the processors 202. Furthermore, since the memory 212 may store the data being copied by the DMM 213, the DMM 213 may be located in a location near the memory 212, for example, within the MCH 208, the memory controller 210, the chipset 206, etc. However, the DMM 213 may be located elsewhere in the system 200 such as within the processor(s) 202 or within a network controller, e.g., within the network adapter 230 (such as shown in FIG. 2).

Referring to FIG. 2, a hub interface 218 may couple the MCH 208 to an input/output control hub (ICH) 220. The ICH 220 may provide an interface to input/output (I/O) devices coupled to the computing system 200. The ICH 220 may be coupled to a bus 222 through a peripheral bridge (or controller) 224, such as a peripheral component interconnect (PCI) bridge, a universal serial bus (USB) controller, etc. The bridge 224 may provide a data path between the processor 202 and peripheral devices. Other types of topologies may be utilized. Also, multiple buses may be coupled to the ICH 220, e.g., through multiple bridges or controllers. For example, the bus 222 may comply with the PCI Local Bus Specification, Revision 3.0, Mar. 9, 2004, available from the PCI Special Interest Group, Portland, Oreg., U.S.A. (hereinafter referred to as a “PCI bus”). Alternatively, the bus 222 may comprise a bus that complies with the PCI-X Specification Rev. 2.0a, Apr. 23, 2003, (hereinafter referred to as a “PCI-X bus”), available from the aforesaid PCI Special Interest Group, Portland, Oreg., U.S.A. Alternatively, the bus 222 may comprise other types and configurations of bus systems. Moreover, other peripherals coupled to the ICH 220 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), etc.

The bus 222 may be coupled to an audio device 226 (e.g., to communicate and/or process audio signals), one or more disk drive(s) 228, and a network adapter 230. Other devices may be coupled to the bus 222. Also, various components (such as the network adapter 230) may be coupled to the MCH 208 in some embodiments of the invention. In addition, the processor 202 and the MCH 208 may be combined to form a single chip. Furthermore, the graphics accelerator 216 may be included within the MCH 208 in other embodiments of the invention.

Additionally, the computing system 200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 228), a floppy disk, a compact disk ROM (CD-ROM), a digital versatile disk (DVD), flash memory, a magneto-optical disk, or other types of nonvolatile machine-readable media suitable for storing electronic instructions and/or data.

The memory 212 may include one or more of the following in an embodiment: an operating system(s) (O/S) 232, application(s) 234, device driver(s) 236, buffers 238, descriptors 240, and protocol driver(s) 242. Programs and/or data in the memory 212 may be swapped into the disk drive 228 as part of memory management operations. The application(s) 234 may execute (on the processor(s) 202) to communicate one or more packets 246 with one or more computing devices coupled to the network 102 (such as the devices 104-114 of FIG. 1). In an embodiment, a packet may be a sequence of one or more symbols and/or values that may be encoded by one or more electrical signals transmitted from at least one sender to at least on receiver (e.g., over a network such as the network 102). For example, each packet 246 may have a header 246A that includes various information that may be utilized in routing and/or processing the packet 246, such as a source address, a destination address, packet type, etc. Each packet may also have a payload 246B that includes the raw data (or content) the packet is transferring between various computing devices (e.g., the devices 104-114 of FIG. 1) over a computer network (such as the network 102).

In an embodiment, the application 234 may utilize the O/S 232 to communicate with various components of the system 200, e.g., through the device driver 236. Hence, the device driver 236 may include network adapter (230) specific commands to provide a communication interface between the O/S 232 and the network adapter 230. For example, the device driver 236 may allocate one or more buffers (238A through 238N) to store packet data, such as the packet payload 246B. One or more descriptors (240A through 240N) may respectively point to the buffers 238. A protocol driver 242 may implement a protocol driver to process packets sent over the network 102, according to one or more protocols.

In an embodiment, the O/S 232 may include a protocol stack that provides the protocol driver 242. A protocol stack generally refers to a set of procedures or programs that may be executed to process packets sent over a network (102), where the packets may conform to a specified protocol. For example, UDP packets may be processed using a UDP stack. The device driver 236 may indicate the buffers 238 to the protocol driver 242 for processing, e.g., via the protocol stack. The protocol driver 242 may either copy the buffer content (238) to its own protocol buffer (not shown) or use the original buffer(s) (238) indicated by the device driver 236. In one embodiment, the data stored in the buffers 238 may be transmitted over the network 102 by the adapter 230, e.g., after being segmented by the DMM 213 as discussed with reference to FIGS. 3-4.

In some embodiments, the network adapter 230 may include a (network) protocol layer for implementing the physical communication layer to send and receive network packets to and from remote devices over the network 102. The network 102 may include any type of computer network such as those discussed with reference to FIG. 1. The network adapter 230 may further include a DMA engine, which may write packets to buffers (238) assigned to available descriptors (240). Additionally, the network adapter 230 may include a network adapter controller, which includes hardware (e.g., logic circuitry) and/or a programmable processor to perform adapter related operations. In an embodiment, the adapter controller may be a MAC (media access control) component. The network adapter 230 may further include a memory, such as any type of volatile/nonvolatile memory, and may include one or more cache(s).

Furthermore, in an embodiment, components of the system 200 may be arranged in a point-to-point (PtP) configuration. For example, processors, memory, and/or input/output devices may be interconnected by a number of point-to-point interfaces.

The charts in FIGS. 3 and 4 illustrate flows that logic (such as the DMM 213 of FIG. 2) may follow when performing UDP segmentation offload with and without pacing, respectively, according to some embodiments.

Referring to FIGS. 1 through 3, at an operation 302, one or more descriptors (e.g., descriptors 240) may be read from a host memory (e.g., memory 212). At an operation 304, it may be determined whether to perform UDP segmentation offload (e.g., based on a determination (by, for example, a logic such as the processor 202 or other logic in the system 200) that indicates the existence and/or availability of the DMM 213 in the system). Generally, UDP segmentation may be used to convert a relatively large transmit requests into multiple UDP datagrams, each one of a maximum transmission unit (MTU) size. For example, Internet protocol television (IPTV) applications may transmit video streams as UDP datagrams. Even though these applications may send large amounts of data, the video stream may be sent as 1,316 byte UDP datagrams. This may help the transmitting application to recover from packet loss by transmitting just the lost datagram(s) and also to possibly pace the datagram and avoid/reduce overwhelming the set-top boxes that receive the IPTV streams. UDP transmit request currently may take considerable number of CPU cycles, and this limits the number of clients a given server may support without introducing quality of service issues. UDP segmentation takes care of this problem by allowing the application to send large amount of data to the respective data movement module (e.g., logic 213) in one embodiment.

If UDP segmentation offload is not to be performed, other transmission operations may be performed at an operation 306 and the method may terminate thereafter. Otherwise, segment size (308) and MTU size (310) may be determined. At an operation 312, if the segment size is greater than MTU size, the corresponding descriptor (e.g. descriptors 240A-240N) may be updated, e.g., with a transmit error status indicated, at an operation 314. The method 300 may terminate after operation 314. However, if the segment size (308) is smaller than or equal to the MTU size (310), a direct memory access (DMA) operation may be performed on UDP, IP, and/or Ethernet headers stored in the host memory (e.g., memory 212) an operation 316. An operation 318, the DMA may be performed on data from host memory having a length set to the minimum of MTU size minus the size of the data header or the actual data length. At operation 320, the UDP, IP, and/or the Ethernet header may be added to the segment to be transmitted. At an operation 322, the data length may be adjusted by deducting the length determined at operation 318.

At an operation 324, the segment may be transmitted (e.g., over the network 102). At operation 3262 may be determined whether the data length is null. As shown in FIG. 3, operations 318-326 may be repeated until the data length reaches zero at operation 326, at which point, a corresponding descriptor may be updated with transmit completion status at operation 328.

Referring to FIG. 4, an embodiment of a method that performs UDP segmentation offload with pacing. Operations 402 through 424 may follow a similar process such as discussed with reference to operation 302 through 324, respectively, in some embodiments such as those discussed with reference to FIG. 3. As long as operation 426 determines that the data length is not null, an operation 428 may wait for an inter segment time period (e.g., which may be a user configurable time period, a time period determined without user intervention, for example, based on network conditions, protocol requirements, hardware/software requirements, etc., or combinations thereof) before continuing at operation 418. After the data length reaches zero at operation 426, at operation 430, a corresponding descriptor (e.g., descriptors 240) may be updated with transmit completion status.

In an embodiment, an application (e.g., application 234) may also specify the segment size (e.g., 1,316 bytes) that is obtained at operations 308 or 408. For example, the application may define a segment size based on user input, network conditions, protocol requirements, hardware/software requirements, etc., or combinations thereof. Moreover, the DMM 213 may accordingly segment a relatively large data block into multiple UDP segments and transmits the data as discussed with reference to FIGS. 3 and/or 4, for example.

In some embodiments, UDP segmentation (such as discussed with reference to FIGS. 3 and/or 4) reduces CPU utilization. In order to avoid or reduce packet loss by overrunning the small packet buffers on client devices, hardware may pace the datagrams at a predefined rate (such as discussed with reference to operation 428 of FIG. 4). This rate may be configurable by the application and/or configuration software for certain UDP sessions.

Also, not all applications may be sending small datagrams. Such applications may transmit a relatively large datagram and this datagram fragmented into MTU size IP fragments by the OS UDP/IP stack and passed to network controller as single IP fragments for transmission over the wire in some embodiments. Generating IP fragments may take considerable CPU cycles, however. Accordingly, the network controller may generate IP fragments in some embodiments.

In some embodiments, UDP may be used such that an application (e.g., application 234) may create a single socket and transmit data to multiple receivers. Certain audio/video streaming applications may generate a single UDP socket and send the same data to multiple receiving agents/clients. This may be done to avoid or reduce administrative overhead associated with generation and management of multicast domains. For example, to save CPU cycles and reduce memory read bandwidth, the network controller (e.g., adapter 230) may be assigned a set of client four tuples and a data buffer. Generally, a tuple is a finite sequence (also known as an “ordered list”) of objects, each of a specified type. A tuple containing n objects is known as an “n-tuple”. For example the 4-tuple (or “quadruple”), with components of respective types PERSON, DAY, MONTH and YEAR, could be used to record that a certain person was born on a certain day of a certain month of a certain year. The network controller may then read the data once from memory and then transmit the data to all clients in the set. This may reduce CPU cycles and/or memory bandwidth associated with UDP data transmission in some embodiments.

In various embodiments of the invention, the operations discussed herein, e.g., with reference to FIGS. 1-4, may be implemented as hardware (e.g., logic circuitry), software, firmware, or any combinations thereof, which may be provided as a computer program product, e.g., including a machine-readable or computer-readable medium having stored thereon instructions (or software procedures) used to program a computer (e.g., including a processor) to perform a process discussed herein. The machine-readable medium may include a storage device such as those discussed with respect to FIGS. 1-4.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a buffer to store a user datagram protocol (UDP) packet payload;
a data movement module (DMM) to segment the UDP packet payload into a plurality of segments, wherein a size of each of the plurality of segments is less than or equal to a maximum transmission unit size in accordance with UDP; and
a network adapter to transmit the plurality of segments over a computer network in accordance with the UDP to one or more receiving agents.

2. The apparatus of claim 1, wherein the network adapter comprises the DMM.

3. The apparatus of claim 1, further comprising a chipset coupled to the network adapter, wherein the chipset comprises the DMM.

4. The apparatus of claim 1, further comprising a memory to store the buffer and one or more descriptors corresponding to the buffer.

5. The apparatus of claim 4, wherein the DMM is to update a transmit completion status associated with one or more of the descriptors after the plurality of segments are transmitted.

6. The apparatus of claim 1, wherein the DMM is to cause the network adapter to wait for an inter segment time period prior to transmitting a next one of the plurality of segments.

7. The apparatus of claim 1, further comprising a memory to store the buffer and an application, wherein the size is defined by the application.

8. The apparatus of claim 1, wherein the DMM is to cause the network adapter to wait for a user configurable inter segment time period prior to transmitting a next one of the plurality of segments.

9. A method comprising:
reading a UDP packet payload from a buffer;
segmenting the payload into a plurality of segments, wherein each of the plurality of segments has a size that is less than or equal to a maximum transmission unit (MTU) size in accordance with UDP; and
transmitting the plurality of segments over a computer network to one or more receiving agents.

10. The method of claim 9, further comprising waiting for an inter segment time period between transmission of each of the plurality of segments.

11. The method of claim 9, further comprising updating one or more descriptors corresponding to the buffer after transmitting the plurality of segments over the computer network.

12. The method of claim 9, further comprising comparing the segment size with the MTU size.

13. The method of claim 9, further comprising an application defining the segment size.

14. The method of claim 9, further comprising storing one or more descriptors corresponding to the buffer in a host memory.

15. The method of claim 9, further comprising updating a value associated with a length of the plurality of segments that remain un-transmitted.
